(19) United States
(12) Patent Application Publication
(10) Pub. No.: US 2009/0192667 A1
(43) Pub. Date: Jul. 30, 2009

(54) TIRE MONITORING SYSTEM

(75) Inventors: Bernard Burreson, Seattle, WA (US); Igal Goniodsky, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ELDEC CORPORATION, Lynnwood, WA (US)

(21) Appl. No.: 12/185,002

(22) Filed: Aug. 1, 2008

Related U.S. Application Data
(60) Provisional application No. 60/953,432, filed on Aug. 1, 2007.

(51) Int. Cl. G06F 17/00; B60B 37/00

(52) U.S. Cl. 701/31; 301/1

(57) ABSTRACT

A plurality of pressure sensors are provided in a tire of an aircraft landing gear, such sensors being carried by the same stem assembly that has the inflation-deflation valve for the tire. A communication microcircuit is provided in the stem. The communication microcircuit is connected to one coil of a stem transformer, with the other coil of the stem transformer being electrically connected to one coil of an axle transformer. The other coil of the axle transformer is coupled to an axle communication circuit which powers the axle and stem circuits and polls the sensors to determine tire pressure.

### CROSS-REFERENCE TO RELATED APPLICATION

This application claims the benefit of Provisional Application No. 60/953,432, filed Aug. 1, 2007, which is expressly incorporated by reference herein.

### BACKGROUND

The present invention relates to a system for monitoring one or more environmental conditions of a tire, particularly air pressure in an airplane tire.

Known pressure monitoring systems are described in the following patent and publication, which are expressly incorporated by reference herein: U.S. Pat. No. 6,889,543, issued May 10, 2005; and PCT Publication WO 2005/109239, published Nov. 17, 2005. See also the references cited and referred to in these documents.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a system for monitoring an environmental condition of a tire. The system can be particularly adapted to monitor tire pressure for each of several tires of an aircraft landing gear. In one embodiment of the invention, a plurality of pressure sensors are provided in each tire, such sensors being carried by the same stem assembly that has the inflation-deflation valve. A communication microcircuit is provided in the stem. The communication microcircuit is connected to one coil of a stem transformer. The other coil of the stem transformer is electrically connected to a coil (the “rotor” coil) of an axle transformer unit. The other coil of the axle transformer unit (the “stator” coil) is coupled to an axle communication circuit. The axle communication circuit is in communication with an information system which is capable of powering the axle and stem circuits and polling the sensor units to determine tire pressure.

In one aspect of the invention, the axle stator coil is mounted in a socket of the outer portion of the axle, and the rotor coil is positioned concentrically inside the stator coil. In this arrangement, the rotor coil can be carried on the inner end of a stub projecting inward from the hubcap which rotates with the wheel.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatic axial section of an aircraft tire, wheel, and axle assembly having a tire monitoring system in accordance with the present invention;

FIG. 2 is an enlarged top perspective of the hub portion of the tire-wheel assembly of FIG. 1, with parts broken away;

FIG. 3 is a further enlarged, fragmentary, detail axial section of a portion of the assembly of FIG. 1;

FIG. 4 is a corresponding detail section with parts broken away and parts shown in section; and

FIG. 5 is a corresponding detail view with parts shown in exploded relationship;

FIG. 6 is a simplified diagram of aspects of the tire monitoring system in accordance with the present invention;

FIG. 7 is a flow chart illustrating operation of an embodiment of a tire monitoring system in accordance with the present invention; and

FIG. 8 is a top perspective of a hand-held tire pressure reader that can be used with the monitoring system of the present invention.

### DETAILED DESCRIPTION

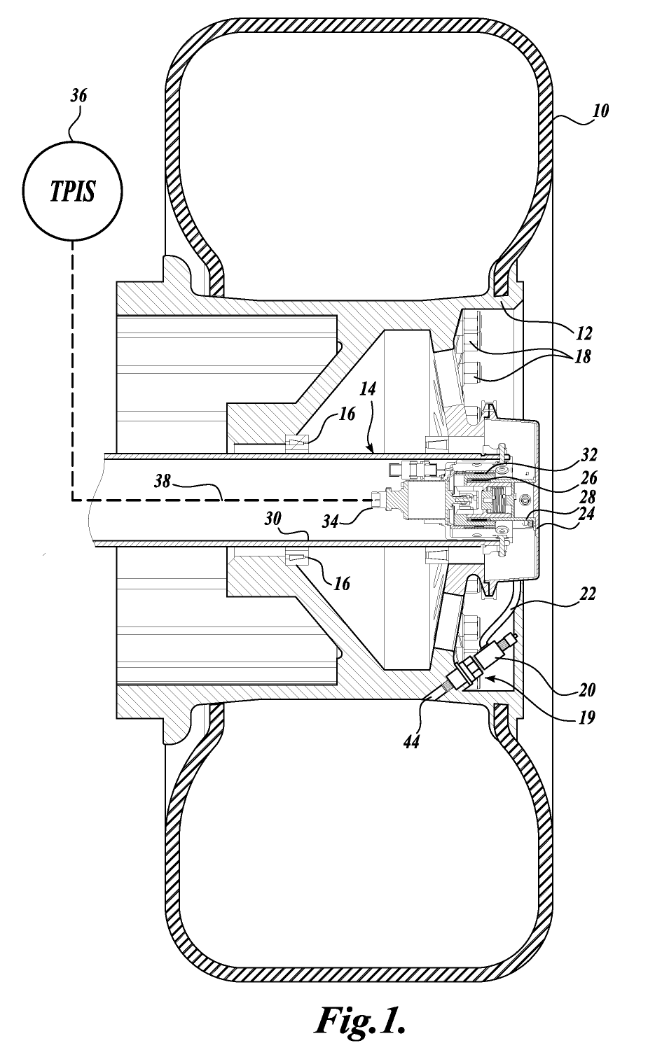

A representative aircraft tire-wheel-axle assembly having a tire monitoring system in accordance with the present invention is shown in axial section in FIG. 1. The conventional aircraft tire 10 is mounted on the conventional wheel 12. The axle assembly 14 rotatably mounts the wheel, such as through bearings 16. The wheel and axle assembly are joined by lug bolts and nuts 18. In a conventional construction, a valve stem is provided at location 19 with an internal valve for inflation and deflation of the tire. As discussed in more detail below, the stem assembly 20 used in the present invention includes the conventional valve at the exterior end portion, but temperature and pressure sensors are mounted at the interior end portion of the stem assembly. Such sensors are in communication with the interior volume of the tire. Pressure information and, if desired, temperature information, are conveyed from the sensors in the form of an electrical signal through a cable 22. The cable extends into the hubcap 24 which rotates with the wheel. The inner end of cable 22 is connected to an annular transformer “rotor” winding 26 mounted on a stub 28 that extends axially inward into a socket of the axle 30. Annular coil 26 is surrounded by the concentric “stator” coil 32 mounted in the axle (i.e., nonrotatable relative to the axle). Transformer winding 32 is coupled to an IC board and/or microprocessor 34. Board 34 is coupled to a tire pressure information system (TPIS) 36, which may be part of a tire brake monitoring unit (TBMU) having functions in addition to those described herein. The connection can be by a two-wire cable diagrammatically represented at 38.

In general, the TPIS powers the board 34 and energizes the primary stator winding 32. Primary winding 32 is coupled to the secondary rotor winding 26 which, in turn, is electrically connected to the electronics of the pressure-sensing valve stem assembly 20. Such assembly also includes primary and secondary coils, microprocessor, and, preferably, a plurality of temperature and pressure sensors for redundant polling of the pressure and temperature of air within the tire. The TPIS communicates with controls and indicators of the aircraft for monitoring the tire pressure and temperature (or the temperature sensor can be used for temperature compensation). In addition, signals passed through the transformer coils at the stem also alter the adjacent magnetic field in such a way that a hand-held probe can be used to measure the tire pressure when the aircraft is on the ground.

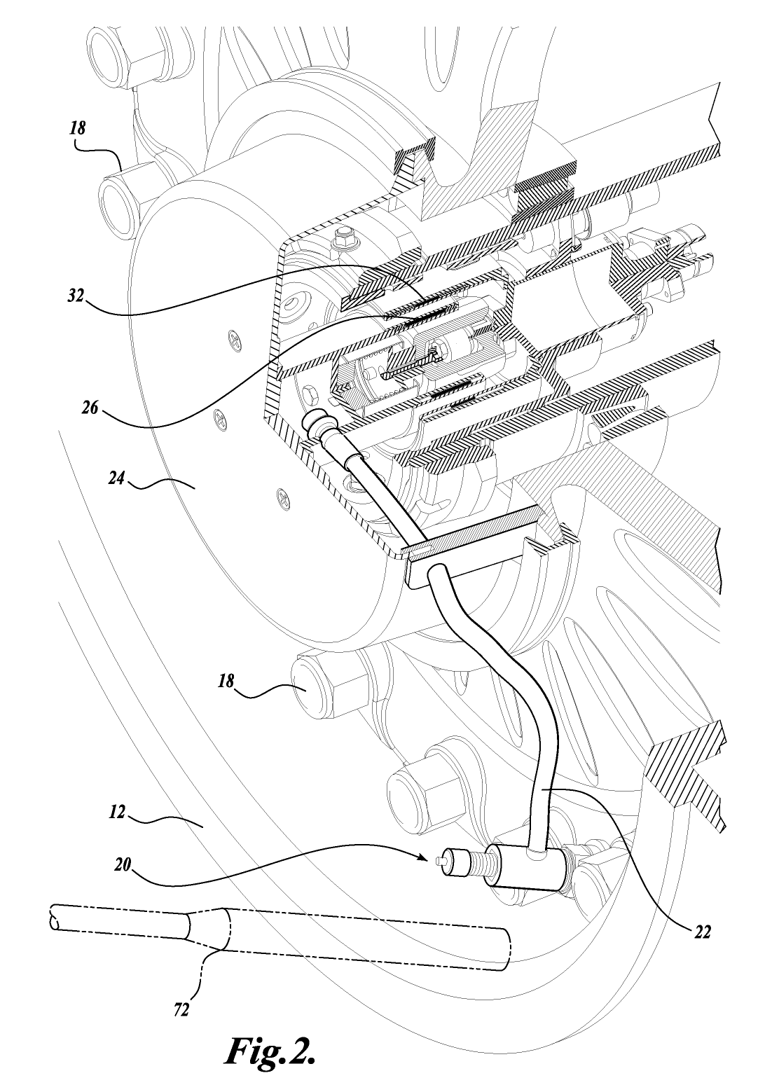

FIG. 2 is an enlarged perspective view illustrating many of the same mechanical components as FIG. 1, namely, the wheel 12, lug bolts and nuts 18, stem assembly 20, cable 22, hub cap 24, hub cap secondary (rotor) coil 26, and axle primary (stator) coil 32. The wires passing through the cable 22 from the stem assembly 20 to the axle rotor coil 26 and the axle circuit board are deleted for ease of illustration.

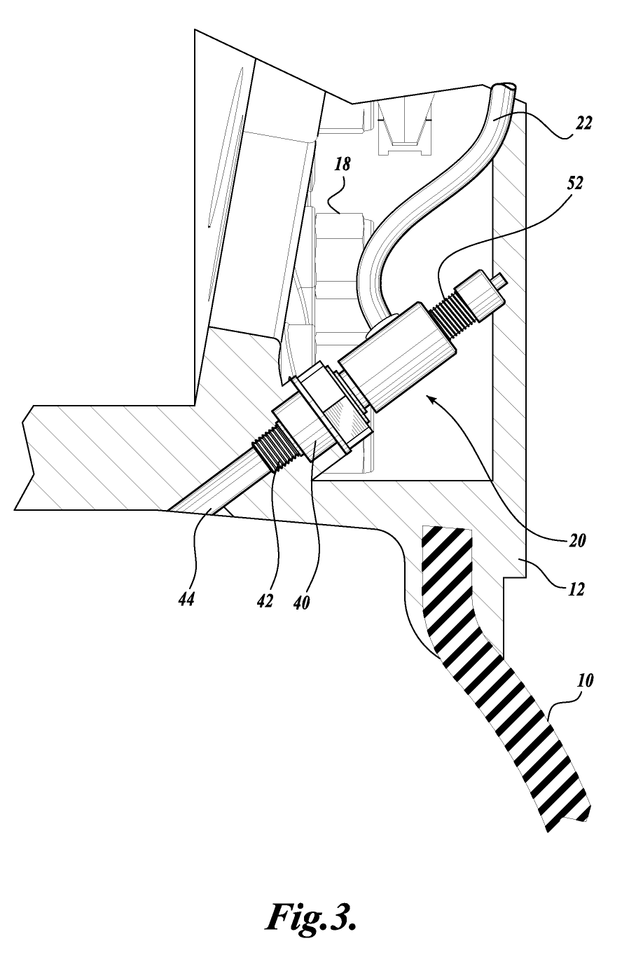

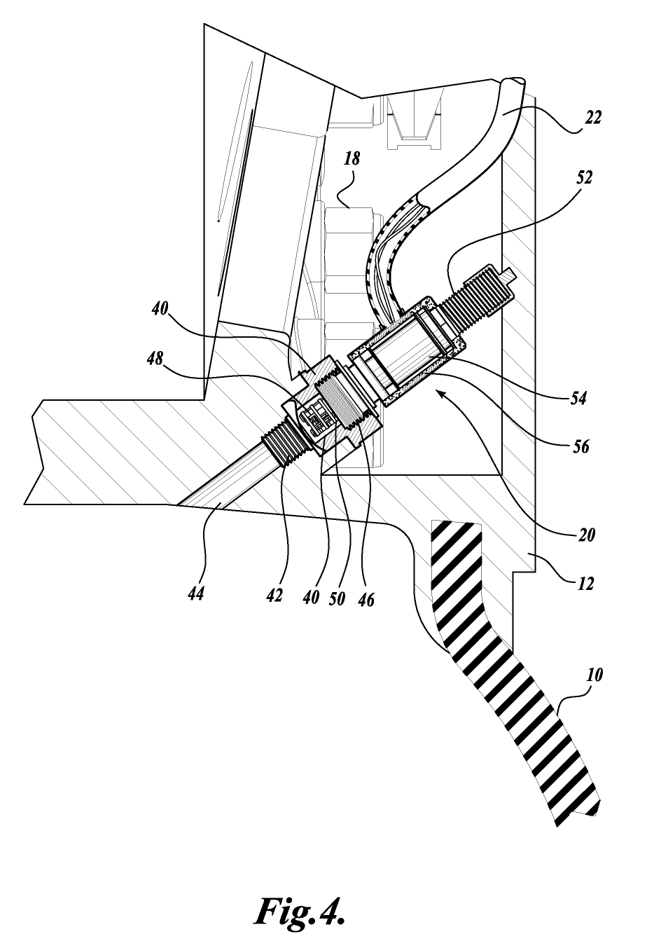

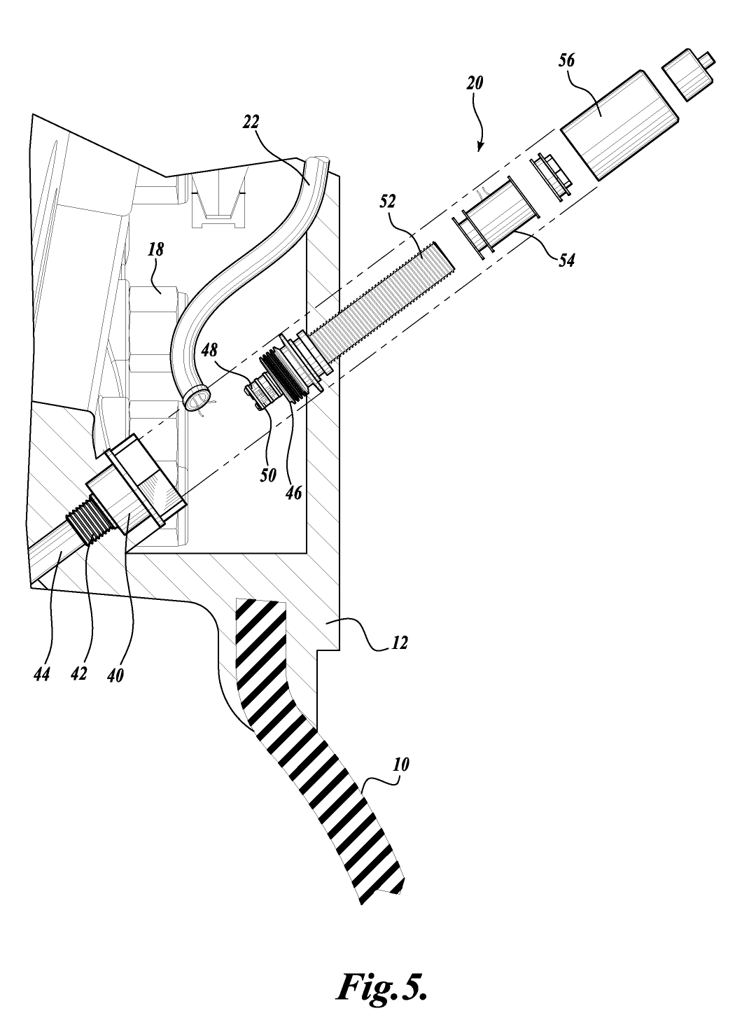

Aspects of the stem assembly 20 are best seen in FIGS. 3-5. The base of the stem assembly includes a hollow mounting bolt 40 with an inner threaded end portion 42 that is sized to fit the standard threaded socket for an inflation-deflation valve stem. This socket is formed in the outer portion of the bore 44 that communicates with the interior volume of the tire 10. The remainder of the stem assembly 20 is mounted in the bolt 40 by a threaded connection 46 seen in FIG. 4. The body of the stem assembly preferably includes a plurality of pressure sensors 48, such as three in each assembly 20, and a communication circuit board or microprocessor 50, shown diagrammatically in FIGS. 4 and 5. The pressure sensors and, if desired, one or more temperature sensors, are exposed to air within the tire by way of the bore 44 and hollow mounting nut 40. The outer portion 52 of the stem body has the standard inflation-deflation valve.

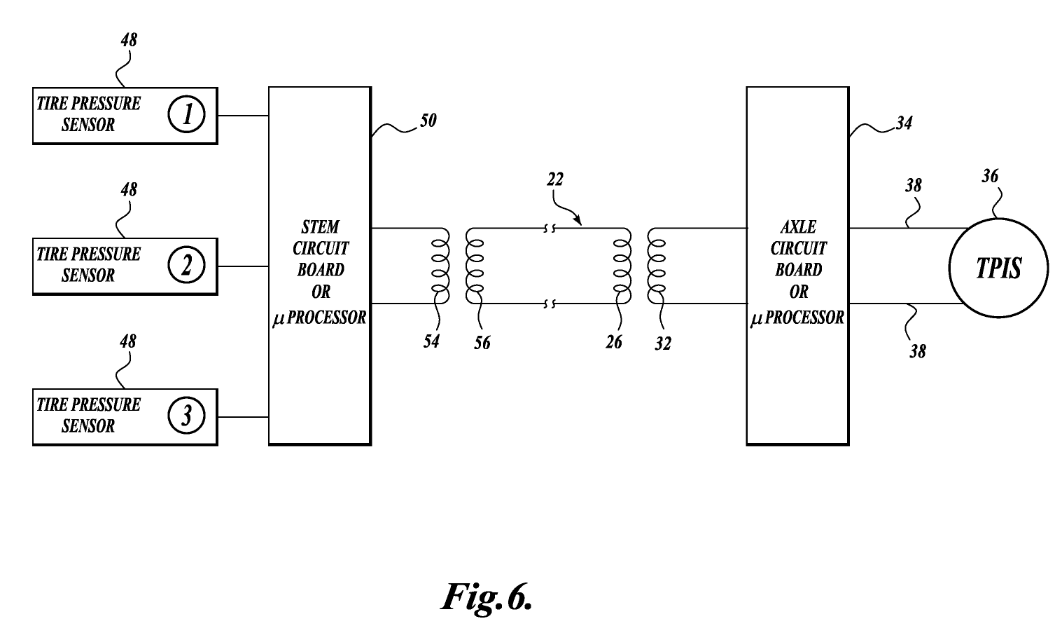

The stem assembly 20 includes a transformer secondary winding 54 that is electrically coupled to the stem circuit board or a microprocessor 50. A primary winding 56 is telescoped over the secondary winding to complete the communication couple. The two wire cable 22 connects to the primary winding 56 and extends from the assembled unit to the axle transformer. A simplified diagram of the components is shown in FIG. 6. Multiple pressure sensors 48, preferably three for each tire, are coupled to the stem circuit board or microprocessor 50. The stem circuit board or microprocessor is electrically connected to the secondary stem coil 54. The communication couple at the stem side is completed by the stem primary coil 56 which is telescoped concentrically over the secondary coil 54. The wires through the cable 22 electrically connect the stem primary coil 56 with the axle secondary (rotor) coil 26. Coil 26 is mounted on the hub cab stem as described above and is magnetically coupled to the primary (stator) coil 32 which is mounted in the axle socket. Coil 32 is electrically connected to the axle circuit board or microprocessor 34 which, in turn, is in communication with the TPIS 36, such as by wires 38.

### EXAMPLE 1

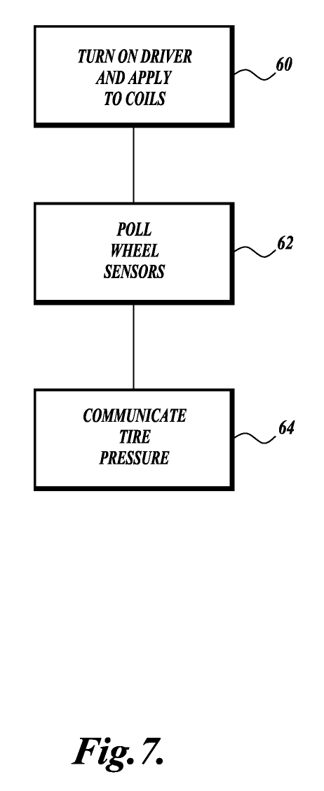

For an aircraft having 14 wheels, there can be 14 driver circuits in the TPIS, one for each wheel. It may be desirable for the aircraft control systems, such as the TBMU, to have updated tire pressure information every two seconds. The TPIS can be designed to drive, modulate, and demodulate four drivers at a time and multiplex the driving such that all 14 wheels can be communicated with in the allotted two-second time frame. With reference to FIG. 7, this is achieved by first applying a driver signal from the TPIS to the microprocessor and coils (box 60), then polling the wheel sensors (box 62), and communicating the tire pressure information to the control system (box 64).

More specifically, in a representative system, the stem assembly 20 monitoring the pressure of each tire has three individual microcircuits for monitoring the pressure. Each circuit is capable of its own communication. Thus, during the reading of one stem assembly, the TPIS is actually reading three separate channels in sequence. For example, if it were reading wheel one, channel one, it could also be reading channel one of wheels two, three, and four. Then it would read channel two, followed by channel three of the same wheels. After this was done, the TPIS sequences to read wheels five, six, seven, and eight, all three channels of each; then wheels nine through 12 and their three channels. Finally, the TPIS would read wheels 13 and 14 and their three channels.

The sequence to communicate to the stem assembly on any particular wheel can begin by first turning on the driver, which outputs a continuous sine wave of, for example, 134.2 kHz. This continuous signal is coupled from the TPIS differential driver, down the two-wire shielded cables 38 to the axle circuit 34, through the axle transformer, which allows the secondary 26 of the transformer to rotate relative to the primary 32. The secondary 26 of the axle transformer connects by the cable 22 through the hubcap 24 to the stem assembly transformer primary 56. The stem assembly 20 has the internal coil 54 that forms the secondary of the stem transformer.

ASIC modulation parameters can be used for bit timing information. Design and operation can be totally based on standard electronic transformer coupling, such that there are no antennae radiation characteristics, unlike the RF antenna systems used in the patent and publication referred to above. The TPIS box (which may be part of the TBMU) contains the processors, power supplies, and drivers to drive signals and read data from each of the monitored wheels on the airplane.

### Additional Features

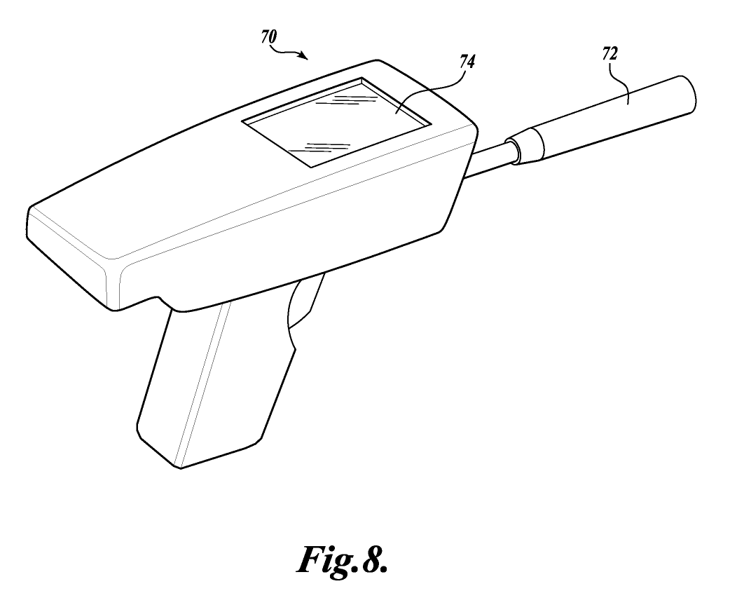

In the example described above, redundant pressure information from each wheel is communicated to the TPIS which is part of the control system for the aircraft. The driving and communication signal to and from the stem assembly is by way of the magnetic coupling of the stem assembly transformer consisting of primary and secondary coils 56 and 54. The same driving signal can be applied wirelessly adjacent to the stem assembly by a hand-held remote unit 70 of the type shown in FIG. 8. Such remote unit has a probe end 72 for positioning adjacent to the stem assembly transformer and an electronic circuit for creating a magnetic field equivalent to that which would be created by the TPIS. For example, the probe end 72 is shown in broken lines in FIG. 2. Similarly, the circuitry of the hand-held unit 70 includes the processors to read data from the sensors, in lieu of obtaining the tire pressure from the TPIS, such as when the aircraft is at rest. In the illustrated embodiment, the hand-held unit 70 has an electronic display 74 for indicating the tire pressure. A technician can move from wheel to wheel and record tire pressure without relying on the internal control system of the aircraft. The sequence of operation at each wheel is the same as that indicted in FIG. 7. The hand-held unit applies the driving signal (box 60), polls the sensors (box 62), and communicates the tire pressure (by supplying a read out of the pressure on the display—box 64).

While illustrative embodiments have been illustrated and described, it will be appreciated that various changes can be made therein without departing from the spirit and scope of the invention.

The embodiments of the invention in which an exclusive property or privilege is claimed are defined as follows:

1. A monitoring system for a tire mounted on a wheel which is rotatably carried on an axle, said system comprising:
a stem assembly mounted on the wheel and having an inner end portion exposed to the interior volume of the tire, the stem assembly having a sensor at the inner end portion for detecting an environmental condition of the internal volume of the tire, the stem assembly having an outer end portion remote from the inner end portion and the interior volume of the tire; and
a communication system for transmitting information of the environmental condition, the communication system including a transformer having an annular primary coil mounted in an axial socket in the axle and an annular secondary coil coaxial with the primary coil, the primary coil being nonrotatable relative to the axle and the secondary coil being mounted to rotate with the wheel, one of the coils being positioned within the other of the coils and the coils being magnetically coupled for transmission of information without RF antenna radiation.

2. The system of claim 1, in which the environmental condition is tire pressure.

3. The system of claim 2, in which the stem assembly includes a plurality of pressure sensors exposed to the interior volume of the tire, and the communication system includes a tire pressure information system for polling the sensors.

4. The system of claim 2, in which the communication system includes a stem transformer having a secondary coil coupled to the sensor and a primary coil telescoped over the secondary coil, magnetically coupled therewith, and electrically connected to the axle transformer.

5. The system of claim 4, and a hand-held unit having a probe for wirelessly coupling to the stem transformer to detect tire pressure sensed by the sensor.

6. The method of monitoring tire pressure of an aircraft tire, such tire being mounted on a wheel which is rotatably carried on an axle, said method comprising:
mounting a pressure sensor on the inner end portion of a stem assembly coupled to the wheel at a location where the sensor is exposed to the interior volume of the tire; and
sending a signal indicating the pressure detected by the sensor to an axle transformer having annular primary and secondary coils one of which is nonrotatable relative to the axle and the other of which rotates with the wheel, one of said coils being mounted within the other of said coils and being magnetically coupled thereto for transmitting tire pressure information by the magnetic coupling without RF antenna radiation.

7. The method of measuring tire pressure of an aircraft tire, such tire being mounted on a wheel which is rotatably carried on an axle, said method comprising:
mounting a pressure sensor on the inner end portion of a stem coupled to the wheel at a location where the sensor is exposed to the interior volume of the tire; and
sending a signal indicating the pressure detected by the sensor to a stem transformer having annular primary and secondary coils one of which is telescoped over the other, the coils being mounted on the stem and being magnetically coupled for transmitting tire pressure information by the magnetic coupling without RF antenna radiation.

8. The method of claim 7, including wirelessly detecting the signal by detecting variations in the magnetic field adjacent to the stem transformer using a probe of a hand-held unit.
